(19) United States
(12) Patent Application Publication
(10) Pub. No.: US 2026/0195769 A1
(43) Pub. Date: Jul. 9, 2026

(54) SYSTEM AND METHOD FOR GENERATING ONE OR MORE COMPLIANCE DOCUMENTS FOR DEVELOPMENT OF A VEHICLE

(71) Applicant: FEV North America, Inc., Auburn Hills, MI (US)

(72) Inventors: David LARUE, Auburn Hills, MI (US); Edwin RIVERA, Puebla (MX)

(73) Assignee: FEV North America, Inc., Auburn Hills, MI (US)

(21) Appl. No.: 19/014,395

(22) Filed: Jan. 9, 2025

(51) Int. Cl. G06Q 30/018; G06Q 50/26

(52) U.S. Cl. CPC G06Q 30/018; G06Q 50/265

(57) ABSTRACT

The present invention relates to a method and a system for generating one or more compliance documents for vehicle development. The method involves receiving a user query specifying parameters such as use cases, weight class, performance targets, energy type, propulsion type, software features, and environmental conditions. A processor determines system, subsystem, and component requirements, as well as compliance requirements, using data stored in a memory. The data includes information on systems, subsystems, components, risk levels, compliance standards, and validation tests. The method further categorizes systems and components into risky and non-risky groups, validates compliance with functional safety, cybersecurity, emissions, and connectivity standards, and performs validation tests to ensure alignment. The generated compliance documents incorporate system requirements, compliance strategies, validation results, and industry-standard alignment, providing a system to a component-level guide for vehicle development.

### FIELD

The present disclosure relates to vehicle development. More specifically, the present invention is related to a system and a method for generating one or more compliance documents for development of a vehicle.

### BACKGROUND

The statements in this section merely provide background information related to the present disclosure and may not constitute prior art.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The development of modern vehicles has become an increasingly complex and multidisciplinary process, requiring seamless coordination between engineering areas such as functional design, safety engineering, cybersecurity, and system validation. Further, the vehicle development process is becoming increasingly complex due to rapid advancements in technologies, including electrification, advanced driver-assistance systems (ADAS), and autonomous driving capabilities. These advancements demand not only a high level of precision and traceability but also the ability to meet strict regulatory requirements while adhering to accelerated development timelines. Manufacturers face mounting pressure to deliver cutting-edge designs and functions that meet these expectations without compromising safety, compliance, or efficiency.

One of the central challenges in vehicle development is the fragmented nature of existing processes. Teams working on different aspects of the development lifecycle often operate in silos, using disconnected tools and methodologies. For example, safety engineers may focus on defining safety goals and conducting risk assessments, while cybersecurity experts independently identify vulnerabilities and implement protective measures. This lack of integration creates inefficiencies and inconsistencies, making it harder to align outputs across domains. These gaps can result in duplicated efforts, delays, and costly rework, hindering the overall development process.

Adding to the above-mentioned challenge is the heavy dependence on manual processes for creating requirements, evaluating risks, and drafting compliance documentation. These tasks are resource-intensive and prone to human error, making them both time-consuming and potentially unreliable. Further, drafting hazard assessments or regulatory compliance reports manually often leads to missing critical details or inconsistencies that can undermine the quality and safety of the final product. As vehicle designs grow more complex and the volume of documentation increases, these manual processes become bottlenecks that slow down progress and escalate costs.

Another pressing issue is the difficulty in maintaining traceability throughout the development lifecycle. Aligning high-level use case objectives with system-level functional requirements and the corresponding component-level designs is crucial to ensure compliance and functionality. However, traditional workflows often lack mechanisms to maintain this alignment effectively. As a result, gaps or discrepancies can arise, leading to regulatory non-compliance or functional shortcomings. For instance, if a system-level safety requirement is not adequately reflected in the design of a component, the overall performance or safety of the vehicle could be compromised.

Additionally, the rapid evolution of vehicle technologies and ever-changing regulatory standards create challenges related to scalability and adaptability. Traditional methods often struggle to keep up with the unique demands of new technologies like electrified powertrains or enhanced ADAS features, which require novel design considerations and compliance strategies. Adapting to these new standards, such as UNECE, CFR (FMVSS), or ISO guidelines, becomes increasingly difficult with outdated tools and workflows that lack flexibility.

Finally, the lack of alignment between key domains, such as cybersecurity, functional safety, and system validation, further complicates the development process. These domains often operate in isolation, leading to misaligned objectives and inefficiencies. For example, safety measures defined in one area may not account for cybersecurity vulnerabilities, resulting in unbalanced or incomplete designs. This disjointed approach can increase risks, inflate costs, and compromise the quality of the final product (vehicle).

In light of the challenges supra, there is a long-felt need for a more unified and efficient approach to manage the growing complexity of modern vehicle development.

### SUMMARY

This section provides a general summary of the disclosure and is not a comprehensive disclosure of its full scope or all of its features.

This summary is provided to introduce aspects related to a system and a method for generating a compliance document for development of a vehicle and the aspects are further described below in the detailed description. This summary is not intended to identify essential features of the claimed subject matter nor is it intended for use in determining or limiting the scope of the claimed subject matter.

In an embodiment of the present invention, a method for generating one or more compliance documents for development of a vehicle is disclosed. The method comprises a step of receiving a user query. The user query includes one or more parameters associated with the development of the vehicle. Further, the parameters include at least one of, one or more use cases, weight class, performance targets, components, energy type, propulsion type, software features, operational scenarios, weather considerations, network topology, and communication protocols of the vehicle.

The method further comprises step of determining, via a processor, one or more system, sub-system, and component requirements, one or more compliance requirements for the vehicle, using data associated with development of different vehicles, based on the parameters in the user query.

Further, the data associated with the development of different vehicles are stored in a memory connected to the processor. Furthermore, the data associated with development of different vehicles comprises a plurality of systems and sub-systems required to develop different vehicles, one or more components required for different vehicles based on different parameters of a vehicle, one or more risk levels associated with the systems, sub-systems, and components, a plurality of compliance requirements for different types of vehicles, and a plurality of validation tests associated with different vehicles.

Lastly, the method comprises a step of generating the one or more compliance documents for the development of the vehicle, by using the one or more system, sub-system, and component requirements, and the one or more compliance requirements for the vehicle.

In an aspect of the present invention, the plurality of compliance requirements includes one or more functional safety and performance, cybersecurity, connectivity, emission, and environmental standards.

In an aspect of the present invention, determining one or more system, sub-system, and component requirements, and one or more compliance requirements, further comprises steps of listing one or more systems, sub-systems, and components based on the parameters in the user query, by using the data associated with development of different vehicles and performing risk level assessment on the systems, sub-systems, and components based on one or more parameters in the user query. Further, categorizing the one or more systems, sub-systems, and components into risky and non-risky systems, sub-systems, and components. Additionally, performing one or more safety analyses for detecting faults and failures in the systems, sub-systems, and the components of the vehicle. Further, determining one or more requirements to address the faults and failures and performing one or more validation tests for validating the requirements in the risky and non-risky systems, sub-systems, and components of the vehicle. Lastly, determining compliance of the risky and non-risky systems, sub-systems, and components with a plurality of compliance requirements.

In an aspect of the present invention, one or safety analyses include fault tree analysis (FTA), design failure mode effects analysis, and failure mode, effects, diagnostics analysis (FMEDA), hazard analysis risk assessment (HARA), and threat and risk assessment (TRA).

In an aspect of the present invention, the compliance document includes one or more system, sub-system, and component requirements, one or more Functional Safety (FUSA) and cybersecurity strategies or protocols, and one or more validation tests, ensuring alignment with the plurality of compliance requirements, industry standards, regulations, and safety protocols.

In another aspect of the present invention, a system to generate one or more compliance documents for development of a vehicle is disclosed. The system comprises a processor and a memory connected to the processor. The memory stores computer-executable instructions and data associated with development of different vehicles. The data associated with the development of different vehicles comprise a plurality of systems and sub-systems required to develop different vehicles, one or more components required for different vehicles based on different parameters of a vehicle, one or more risk levels associated with the systems, sub-systems, and components, a plurality of compliance requirements, and one or more validation tests for different types of vehicles.

Further, when the computer-executable instructions are executed by the processor, causes the processor to receive a user query. The user query includes one or more parameters associated with the development of the vehicle. Further, the parameters include at least one of, one or more use cases, weight class, performance targets, components, energy type, propulsion type, software features, operational scenarios, weather considerations, network topology, and communication protocols of the vehicle.

The processor is further configured to determine one or more system, sub-system, and component requirements, and one or more compliance requirements for the vehicle, using the data associated with the development of different vehicles, based on the parameters in the user query. Lastly, the processor is configured to generate the one or more compliance documents for the development of the vehicle, by using the one or more system, sub-system, and component requirements, and the one or more compliance requirements for the vehicle.

Other aspects and advantages of the invention will become apparent from the following description, taken in conjunction with the accompanying drawings, illustrating by way of example the principles of the invention.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a working architecture of a system to generate one or more compliance documents for development of a vehicle, in accordance with an embodiment of the present disclosure.

FIG. 2 illustrates a flow diagram of a method for generating one or more compliance documents for development of a vehicle, in accordance with an embodiment of the present disclosure.

FIG. 3 illustrates a flow diagram of the method for determining one or more system, sub-system, and component requirements, and one or more compliance requirements for a vehicle, to generate the one or more compliance documents for development of the vehicle, in accordance with an embodiment of the present disclosure.

A more complete understanding of the present invention and its embodiments thereof may be acquired by referring to the following description and the accompanying drawings.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

It is to be noted, however, that the reference numerals used herein illustrate only typical embodiments of the present subject matter, and are therefore, not to be considered for limiting its scope, for the subject matter may admit to other equally effective embodiments.

The detailed description includes specific details for the purpose of providing a thorough understanding of the present invention. However, it will be apparent to those skilled in the art that the present invention may be practiced without these specific details.

The present invention relates to a method and system for generating comprehensive compliance documents for vehicle development. The invention integrates computational techniques to streamline and enhance the compliance process, ensuring thorough coverage of all critical aspects of vehicle design and testing.

The invention employs a combination of user-provided queries and data associated with development of different vehicles to determine system, sub-system, and component requirements, and compliance requirements tailored to specific vehicle parameters. The invention determines the system, sub-system, and component requirements, and compliance requirements, by accessing data associated with development of different vehicles, stored in a memory.

The data includes systems and sub-systems required to develop different vehicles, components required for different vehicles based on different parameters of a vehicle, risk levels associated with the systems, sub-systems, and components, and a plurality of compliances requirements, and one or more validation tests for different types of vehicles.

The generated compliance documents include detailed insights into system, sub-system, and component requirements, Functional Safety (FUSA) and cybersecurity strategies or protocols, and validation tests, ensuring alignment with regulatory standards and safety protocols. By addressing these compliances, the invention optimizes the vehicle development lifecycle, and enhances the reliability and safety of the final product (vehicle).

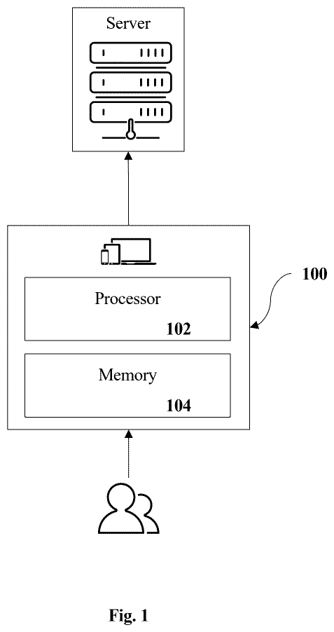

FIG. 1 illustrates a working architecture of a system 100 to generate one or more compliance documents for development of a vehicle, in accordance with an embodiment of the present disclosure. The system 100 may include at least one processor 102 and a memory 104. Further, the processor 102 may be connected with the memory 104. Furthermore, the memory 104 may store one or more processor-executable instructions and a plurality of data associated with development of different vehicles.

In an embodiment, the system 100 may be a user device. Furthermore, the user device may include but is not limited to, smartphones, laptops, tablets, and computers.

In an embodiment, the processor 102 may include one or more general-purpose processors (e.g., INTEL® or Advanced Micro Devices® (AMD) microprocessors) and/or one or more special-purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

In an embodiment, the memory 104 may include but is not limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions.

In an embodiment, the vehicles may include but are not limited to, four-wheeler vehicles, two-wheeler vehicles, marine vehicles, aircrafts, and military-use vehicles.

Referring to FIG. 1 again, the processor 102 of the system 100 executes the computer-executable instructions stored in the memory 104, to generate the compliance document for development of the vehicle. The computer-executable instructions, when executed by the processor, configured the processor to receive at least one user query from a user of the user device (system 100). The user query includes one or more parameters associated with development of the vehicle. The one or more parameters may be diverse and may be customizable.

Further, the parameters may define requirements of the vehicle to be developed. Furthermore, the parameters include but are not limited to, at least one of, one or more use cases, weight class, performance targets, components, energy type, propulsion type, software features, operational scenarios, weather considerations, network topology, and communication protocols of the vehicle.

The use cases may define one or more intended uses of the vehicle to be developed. For example, a vehicle may be developed for commercial applications like delivery trucks, or personal use such as family sedans, or specialized purposes like military or emergency vehicles. Further, the weight class of the vehicle, may be categorized as light-duty, medium-duty, or heavy-duty. The weight class may directly impact design considerations and compliance standards, as systems, sub-systems and components of the vehicle differ as per the weight class of the vehicle.

Furthermore, performance targets as parameters may include attributes such as speed, range, fuel efficiency, and durability of the vehicle to be developed. Additionally, the query may include parameters associated with components of the vehicle to be developed, including materials, configurations, and technologies used in components such as engines, batteries, and drive trains. Additionally, the energy type and propulsion system are crucial parameters. The energy type and propulsion type may indicate whether the vehicle will use electric, hybrid, or combustion engines, along with its propulsion architecture.

Users may also define software features and operational scenarios as parameters. The software features and operational scenarios may include, but are not limited to, autonomous driving capabilities or connectivity features, and their performance under different operating conditions.

Furthermore, weather considerations, such as extreme temperatures, precipitation, or humidity, may be included in the parameters to ensure the reliability of the vehicle to be developed, across diverse climatic environments. Finally, network topology and communication protocols, including but not limited to, vehicle-to-vehicle (V2V) or vehicle-to-infrastructure (V2I) connectivity, may be included in parameters to ensure seamless integration with other systems inside and outside the vehicle. The parameters may enable the system to handle a broad spectrum of development scenarios, from autonomous electric cars to heavy-duty industrial vehicles, enhancing its adaptability and utility.

Upon receiving the user query that includes parameters associated with the development of the vehicle, the processor 102 may be further configured to determine one or more system, sub-system, and component requirements, and one or more compliance requirements for the vehicle. The processor 102 may determine the system, sub-system, and component requirements, and one or more compliance requirements for the vehicle based on the parameters in the user query.

The system requirements of the vehicle to be developed, may refer to one or more systems or functional units within the vehicle. The systems or functional units may include, but are not limited to, such as a propulsion system, braking system, infotainment system, and driver assistance system. The systems may include the subsystems. The sub-systems may be interconnected and represent smaller, specialized modules with specific functions. For instance, within the braking system, the subsystems may include hydraulic, electric braking mechanism, anti-lock braking system (ABS), and electronic braking controls. Lastly, the component requirements may be individual parts that make up the systems and sub-systems. The components may include but are not limited to, such as sensors, brake pads, control modules, and hydraulic cylinders. Together, the systems, sub-systems, and components form a hierarchical structure, with components as the building blocks of subsystems, and subsystems as functional modules of systems.

In an embodiment, the plurality of data associated with development of different vehicles may comprise a plurality of systems and sub-systems required to develop different vehicles, one or more components required for different vehicles based on different parameters of a vehicle, one or more risk levels associated with the systems, sub-systems, and components, a plurality of industry standards and statutory regulations, a plurality of compliance requirements for different types of vehicles, and a plurality of validation tests associated with different vehicles.

In an embodiment, the plurality of data associated with development of different vehicles may be customized by the user.

The plurality of data associated with development of different vehicles may further include but is not limited to, records of existing systems, sub-systems, and components used in different vehicles. For systems associated with different vehicles, the data may include data on a plurality of functional units including propulsion systems, braking systems, and connectivity systems. The propulsion systems may include but are not limited to electric, hybrid, and combustion propulsion systems. Further, the braking systems may include but are not limited to, hydraulic, ABS, and electronic braking systems. Furthermore, the connectivity systems may include but are not limited to, infotainment, navigation, and vehicle-to-everything communication. For sub-systems associated with different vehicles and systems, the data may include specialized modules including but not limited to energy storage management in electric vehicles, thermal management systems, and hydraulic control units in braking systems. Furthermore, for components associated with different vehicles, systems, and sub-systems, the data may include but is not limited to parts such as sensors, actuators, batteries, and microcontrollers. Furthermore, the data associated with components may include material specifications, configurations, and performance characteristics of components associated with the vehicle, systems, and sub-systems.

The data associated with development of different vehicles may include but is not limited to, detailed information about risks associated with a plurality of systems, sub-systems, and components. The detailed information about risks ensures a thorough evaluation of potential vulnerabilities of the vehicle, systems, sub-systems, and components to be developed. The detailed information about risks may include but is not limited to, data on failure rates, environmental susceptibilities, cybersecurity threats, and criticality of a plurality of systems, sub-systems, and components in maintaining vehicle safety and performance. For instance, lithium-ion batteries used in electric vehicles may be flagged for risks such as overheating, thermal runaway, and fire hazards. Further, communication modules may be identified for potential cybersecurity vulnerabilities, including unauthorized access and data interception. Further, components critical to safety including braking systems, airbag modules, and steering mechanisms, may be prioritized for rigorous scrutiny due to their vital roles in vehicle operation and passenger protection.

The plurality of data associated with development of different vehicles may further include but is not limited to, a plurality of compliance requirements associated with a plurality of systems, sub-systems, and components of different vehicles. The plurality of compliance requirements ensure alignment with functional, operational, and regulatory standards of vehicles across global markets. The plurality of compliance requirements may include but are not limited to, functional safety and performance, cybersecurity, connectivity, emission, and environmental standards. The functional safety and performance standards include but are not limited to, ISO 26262 for functional safety, which governs the lifecycle of safety-critical systems like propulsion, braking, and steering, and ISO 21448, which focuses on the safety of intended functionality for advanced driver-assistance systems (ADAS). Further, the safety and performance standards may include standards addressing electric vehicles including UNECE R100 and its US counterparts within various CFR regulatory requirements, which outlines safety requirements for electric powertrains, including thermal management and battery protection, and IEC 62660, which specifies safety and performance testing for lithium-ion batteries. Further, the compliance requirements may include ISO 6469-1 through 6469-4, which define specific requirements for onboard rechargeable energy storage systems in hybrid and electric vehicles.

Cybersecurity standards include but are not limited to, ISO/SAE 21434, which establishes guidelines for managing cybersecurity risks throughout the vehicle lifecycle, UNECE R155, which mandates cybersecurity management systems (CSMS) for connected and autonomous vehicles, and UNECE R156 governs over-the-air (OTA) updates, ensuring secure deployment without compromising system functionality. Furthermore, connectivity standards include but are not limited to, IEEE 802.11p, which supports vehicle-to-vehicle (V2V) and vehicle-to-infrastructure (V2I) communications, and ETSI EN 302 637 for cooperative intelligent transport systems (C-ITS), enhance safety and traffic efficiency through reliable communication protocols.

Further, emission and environmental standards may include but are not limited to, EPA and CARB guidelines in the United States of America, which regulate emissions from internal combustion engine (ICE) vehicles, and Euro 6 and Euro 7 standards in Europe, which focus on reducing nitrogen oxides (NOx) and particulate matter. The emission and environmental standards may further include UNECE R83 and R49 which provide international standards for emissions testing and approval for light and heavy-duty vehicles, respectively. Furthermore, noise standards including UNECE R51 ensure that vehicle noise emissions remain within permissible limits, improving environmental compliance.

In addition to the above-mentioned standards, the plurality of data associated with development of different vehicles may further include but is not limited to, validation tests. The validation tests may include but are not limited to, Hardware-in-the-Loop (HIL) and Software-in-the-Loop (SIL). HIL and SIL simulate real-world operating conditions to validate the performance of hardware and software systems of the vehicle. Furthermore, the validation tests may include environmental validation tests that may include but are not limited to, thermal cycle testing for temperature resilience, ingress protection (IP) tests to assess resistance against dust and water, vibration testing to simulate road impacts, and corrosion testing in accordance with ISO 16750.

The plurality of data associated with development of different vehicles may further include but are not limited to, functional safety protocols. The functional safety protocols outline strategies for developing fault-tolerant systems and achieving high diagnostic coverage thresholds. For example, the functional safety protocols may include ISO 13849 for safety-related control systems in machinery, IEC 61508 for functional safety in electronic systems, and EN 50126 for reliability, availability, maintainability, and safety (RAMS) in rail applications, which are increasingly relevant as cross-domain technologies converge in the automotive sector.

By using the plurality of data associated with development of different vehicles, the invention ensures that the compliance documents to be generated are accurate and relevant. The data associated with development of different vehicles further enables the invention to provide precise and actionable outputs tailored to the parameters of the user query. The data associated with development of different vehicles serves a crucial role in the decision-making process, bridging the gap between theoretical compliance standards and practical vehicle development scenarios. It also ensures that the system remains adaptable and future-proof by incorporating evolving standards, updated compliance frameworks, and emerging technologies in the development of the vehicle.

For determining one or more system, sub-system, and component requirements, one or more compliance requirements for the vehicle based on one or more parameters in the user query, the processor 102 may utilize the plurality of data associated with development of different vehicles. The processor 102 may be configured to list one or more systems, sub-systems, and components based on the parameters in the user query, by using the records of existing systems, sub-systems, and components used in different vehicles stored in the data associated with development of different vehicles.

Further, the processor 102 may be configured to perform one or more risk level assessments on the one or more systems, sub-systems, and components based on one or more parameters in the user query. The processor 102 utilizes the detailed information about risks associated with a plurality of systems, sub-systems, and components, stored in the data associated with development of different vehicles. The processor 102 may evaluate functional roles of one or more systems, sub-systems, and components to assess associated risk levels. Further, the processor 102 may be configured to categorize the one or more systems, sub-systems, and components into risky and non-risky systems, sub-systems, and components, based on the one or more risk assessments. Risk may be categorized based on potential failure rates, operational criticality, and susceptibility to hazards. For instance, high-risk components like batteries in electric vehicles or braking subsystems in autonomous cars may require enhanced scrutiny and compliance validation.

Additionally, the processor 102 may be configured to perform one or more safety analyses for detecting faults and failures in the systems, sub-systems, and the components of the vehicle. Further, the processor 102 may be configured to determine one or more requirements to address the faults and failures and perform one or more validation tests for validating the requirements in the risky and non-risky systems, sub-systems, and components of the vehicle. Lastly, the processor 102 may be configured to determine compliance of the risky and non-risky systems, sub-systems, and components with the plurality of compliance requirements.

In an aspect of the present invention, the one or more safety analyses may include but are not limited to, fault tree analysis (FTA), design failure mode effects analysis (FMEDA), and failure mode, effects, diagnostics analysis, hazard analysis risk assessment (HARA), and threat and risk assessment (TRA).

In an embodiment the safety analyses are performed using one or more analytic tools. The analytics tools may include but are not limited to, fault tree analysis tool (FTA), design failure mode effects analysis tool, and failure mode, effects, diagnostics analysis tool (FMEDA), hazard analysis risk assessment tool (HARA), and threat and risk assessment tool (TRA). In an embodiment, the analytics tool may be used to develop the safety analyses based on different vehicles and conditions.

The Fault Tree Analysis (FTA) systematically identifies potential faults and examines their cascading effects on the overall system or vehicle. The Design Failure Mode and Effects Analysis (DFMEA) evaluates potential failure modes during the design phase and assesses their impact on system performance. Additionally, the Failure Mode, Effects, and Diagnostics Analysis (FMEDA) integrates diagnostic capabilities to predict failures and propose mitigation strategies. Furthermore, the Hazard Analysis Risk Assessment (HARA) focuses on identifying and mitigating hazards that could compromise vehicle functionality or safety, particularly for safety-critical systems. Furthermore, the Threat and Risk Assessment (TRA) addresses cybersecurity vulnerabilities, ensuring that vehicle operations and data remain secure against potential threats such as hacking, data breaches, and firmware manipulation.

After performing the safety analyses to detect faults and failures, the processor 102 may be configured to determine one or more requirements to address the faults and failures and perform one or more validation tests for validating the requirements in the risky and non-risky systems, sub-systems, and components of the vehicle. In an embodiment, the one or more validation tests may include but are not limited to, Hardware-in-the-Loop (HIL) and Software-in-the-Loop (SIL). HIL and SIL simulate real-world operating conditions that include the requirements to address the faults and failures, to validate the performance of hardware and software systems of the vehicle.

Lastly, the processor 102 may be configured to determine compliance for the risky and the non-risky systems, subsystems, and components. The processor 102 may validate each system, sub-system and component against the plurality of compliance requirements stored in the data associated with different vehicles. For example, propulsion systems are validated to ensure compliance with emissions regulations, while braking systems are checked for alignment with international safety standards such as UNECE R13 or FMVSS 135. Similarly, electronic control units (ECUs) may undergo cybersecurity assessments to confirm adherence to standards like ISO/SAE 21434 or UNECE R155.

Lastly, the processor 102 may be configured to generate the one or more compliance documents for the development of the vehicle, by using the one or more system, sub-system, and component requirements, and the one or more compliance requirements for the vehicle.

In an aspect of the present invention, the compliance documents may include one or more system, sub-system, and component requirements, one or more Functional Safety (FUSA) and cybersecurity strategies or protocols, and one or more validation tests, ensuring alignment with the plurality of compliance requirements, industry standards, regulations, and safety protocols.

Further, referring to FIG. 1, the system 100 may be connected to one or more servers. The servers may comprise an ML model to generate the compliance document. In an embodiment, the server may be a physical server or a cloud server. In another embodiment, the system 100 may include the ML model and modules associated with the ML model.

In an embodiment, the system 100 may include an interactive display configured to interact with the user. The user may input the user query in the interactive display.

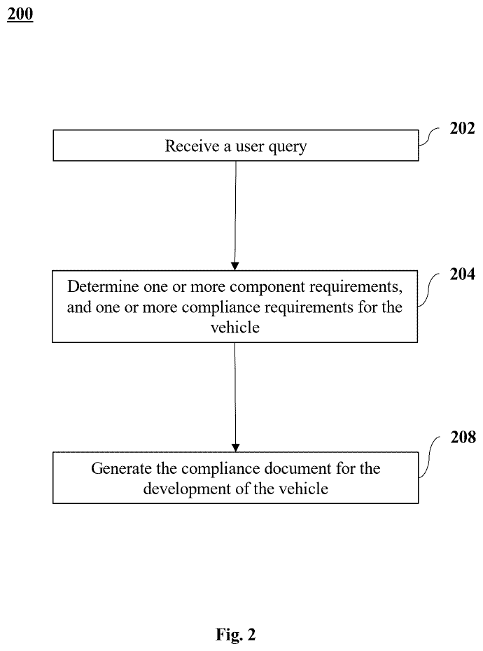

FIG. 2 illustrates a flow diagram of a method 200 for generating a compliance document for development of a vehicle, in accordance with an embodiment of the present invention. The order in which method 200 is described is not intended to be construed as a limitation, and any number of the described method blocks can be combined in any order to implement the method. Additionally, individual blocks may be deleted from the methods without departing from the scope of the subject matter described herein.

Furthermore, the method 200 can be implemented in any suitable hardware, software, firmware, or combination thereof. Furthermore, the above-mentioned methods may be implemented in suitable hardware, computer-readable instructions, or a combination thereof. The steps of such methods may be performed by either a system under the instruction of machine-executable instructions stored on a non-transitory computer-readable medium or by dedicated hardware circuits, microcontrollers, or logic circuits. The method 200 may include the following steps.

At step 202, a processor may receive at least one user query from a user of a user device. The user query includes one or more parameters associated with development of the vehicle. The one or more parameters may be diverse and may be customizable.

In an embodiment, the vehicles may include but are not limited to, four-wheeler vehicles, two-wheeler vehicles, marine vehicles, aircrafts and military-use vehicles.

Further, the parameters may define the requirements of the vehicle to be developed. Furthermore, the parameters include but are not limited to, at least one of, one or more use cases, weight class, performance targets, components, energy type, propulsion type, software features, operational scenarios, weather considerations, network topology, and communication protocols of the vehicle.

The use cases may define the intended use of the vehicle to be developed. For example, a vehicle may be developed for commercial applications like delivery trucks, or personal use such as family sedans, or specialized purposes like military or emergency vehicles. Further, the weight class of the vehicle, may be categorized as light-duty, medium-duty, or heavy-duty. The weight class may directly impact design considerations and compliance standards, as systems, sub-systems and components of the vehicle differ as per the weight class of the vehicle.

Furthermore, performance targets as parameters may include attributes such as speed, range, fuel efficiency, and durability of the vehicle to be developed. Additionally, the query may include parameters associated with components of the vehicle to be developed, including materials, configurations, and technologies used in components such as engines, batteries, and drive trains. Additionally, the energy type and propulsion system are crucial parameters. The energy type and propulsion type may indicate whether the vehicle will use electric, hybrid, or combustion engines, along with its propulsion architecture.

Users may also define software features and operational scenarios as parameters. The software features and operational scenarios may include, but are not limited to, autonomous driving capabilities or connectivity features, and their performance under different operating conditions.

Furthermore, weather considerations, such as extreme temperatures, precipitation, or humidity, may be included in the parameters to ensure the reliability of the vehicle to be developed, across diverse climatic environments. Finally, network topology and communication protocols, including but not limited to, vehicle-to-vehicle (V2V) or vehicle-to-infrastructure (V2I) connectivity, may be included in parameters to ensure seamless integration with other systems inside and outside the vehicle. The parameters may enable the system to handle a broad spectrum of development scenarios, from autonomous electric cars to heavy-duty industrial vehicles, enhancing its adaptability and utility.

At step 204, the processor may be further configured to determine one or more system, sub-system, and component requirements, and one or more compliance requirements for the vehicle.

The processor may determine the system, sub-system, and component requirements, and one or more compliance requirements for the vehicle based on the parameters in the user query. Further, for determining one or more system, sub-system, and component requirements, one or more compliance requirements for the vehicle based on one or more parameters in the user query, the processor may utilize the plurality of data associated with development of different vehicles.

In an embodiment, the plurality of data associated with development of different vehicles may be stored in a memory. Further, the data associated with development of different vehicles may include a plurality of systems and sub-systems required to develop different vehicles, one or more components required for different vehicles based on different parameters of a vehicle, one or more risk levels associated with the systems, sub-systems, and components, a plurality of industry standards and statutory regulations, a plurality of compliance requirements for different types of vehicles, and a plurality of validation tests associated with different vehicles.

The plurality of data associated with development of different vehicles may further include but is not limited to, records of existing systems, sub-systems, and components used in different vehicles. For systems associated with different vehicles, the data may include data on a plurality of functional units including propulsion systems, braking systems, and connectivity systems. The propulsion systems may include but are not limited to electric, hybrid, and combustion propulsion systems. Further, the braking systems may include but are not limited to, hydraulic, electric, ABS, and electronic braking systems. Furthermore, the connectivity systems may include but are not limited to, infotainment, navigation, and vehicle-to-everything communication. For sub-systems associated with different vehicles and systems, the data may include specialized modules including but not limited to energy storage management in electric vehicles, thermal management systems, and hydraulic control units in braking systems. Furthermore, for components associated with different vehicles, systems, and sub-systems, the data may include but is not limited to parts such as sensors, actuators, batteries, and microcontrollers. Furthermore, the data associated with components may include material specifications, configurations, and performance characteristics of components associated with the vehicle, systems, and sub-systems.

The data associated with development of different vehicles may include but is not limited to, detailed information about risks associated with a plurality of systems, sub-systems, and components. The detailed information about risks ensures a thorough evaluation of potential vulnerabilities of the vehicle, systems, sub-systems, and components to be developed. The detailed information about risks may include but is not limited to, data on failure rates, environmental susceptibilities, cybersecurity threats, and criticality of a plurality of systems, sub-systems, and components in maintaining vehicle safety and performance. For instance, lithium-ion batteries used in electric vehicles may be flagged for risks such as overheating, thermal runaway, and fire hazards. Further, communication modules may be identified for potential cybersecurity vulnerabilities, including unauthorized access and data interception. Further, components critical to safety including braking systems, airbag modules, and steering mechanisms, may be prioritized for rigorous scrutiny due to their vital roles in vehicle operation and passenger protection.

The plurality of data associated with development of different vehicles may further include but is not limited to, a plurality of compliance requirements associated with a plurality of systems, sub-systems, and components of different vehicles. The plurality of compliance requirements ensure alignment with functional, operational, and regulatory standards of vehicles across global markets. The plurality of compliance requirements may include but are not limited to, functional safety and performance, cybersecurity, connectivity, emission, and environmental standards. The functional safety and performance standards include but are not limited to, ISO 26262 for functional safety, which governs the lifecycle of safety-critical systems like propulsion, braking, and steering, and ISO 21448, which focuses on the safety of intended functionality for advanced driver-assistance systems (ADAS). Further, the safety and performance standards may include standards addressing electric vehicles including UNECE R100, which outlines safety requirements for electric powertrains, including thermal management and battery protection, and IEC 62660, which specifies safety and performance testing for lithium-ion batteries. Further, the compliance requirements may include ISO 6469-1 through 6469-4, which define specific requirements for onboard rechargeable energy storage systems in hybrid and electric vehicles.

Cybersecurity standards include but are not limited to, ISO/SAE 21434, which establishes guidelines for managing cybersecurity risks throughout the vehicle lifecycle, UNECE R155, which mandates cybersecurity management systems (CSMS) for connected and autonomous vehicles, and UNECE R156 governs over-the-air (OTA) updates, ensuring secure deployment without compromising system functionality. Furthermore, connectivity standards include but are not limited to, IEEE 802.11p, which supports vehicle-to-vehicle (V2V) and vehicle-to-infrastructure (V2I) communications, and ETSI EN 302 637 for cooperative intelligent transport systems (C-ITS), enhance safety and traffic efficiency through reliable communication protocols.

Further, emission and environmental standards may include but are not limited to, EPA and CARB guidelines in the United States of America, which regulate emissions from internal combustion engine (ICE) vehicles, and Euro 6 and Euro 7 standards in Europe, which focus on reducing nitrogen oxides (NOx) and particulate matter. The emission and environmental standards may further include UNECE R83 and R49 which provide international standards for emissions testing and approval for light and heavy-duty vehicles, respectively. Furthermore, noise standards including UNECE R51 ensure that vehicle noise emissions remain within permissible limits, improving environmental compliance.

In addition to the above-mentioned standards, the plurality of data associated with development of different vehicles may further include but is not limited to, validation tests. The validation tests may include but are not limited to, Hardware-in-the-Loop (HIL) and Software-in-the-Loop (SIL). HIL and SIL simulate real-world operating conditions to validate the performance of hardware and software systems of the vehicle. Furthermore, the validation tests may include environmental validation tests that may include but are not limited to, thermal cycle testing for temperature resilience, ingress protection (IP) tests to assess resistance against dust and water, vibration testing to simulate road impacts, and corrosion testing in accordance with ISO 16750

Furthermore, the validation tests may include environmental validation tests including but not limited to, thermal cycle testing for temperature resilience, ingress protection (IP) tests to assess resistance against dust and water, vibration testing to simulate road impacts, and corrosion testing in accordance with ISO 16750.

The plurality of data associated with development of different vehicles may further include but are not limited to, functional safety protocols. The functional safety protocols outline strategies for developing fault-tolerant systems and achieving high diagnostic coverage thresholds. For example, the functional safety protocols may include ISO 13849 for safety-related control systems in machinery, IEC 61508 for functional safety in electronic systems, and EN 50126 for reliability, availability, maintainability, and safety (RAMS) in rail applications, which are increasingly relevant as cross-domain technologies converge in the automotive sector.

At step 206, the processor may be configured to generate the one or more compliance document for the development of the vehicle, by using the one or more system, sub-system, and component requirements, and the one or more compliance requirements for the vehicle.

In an aspect of the present invention, the one or more compliance document includes one or more system, sub-system, and component requirements, one or more Functional Safety (FUSA) and cybersecurity strategies or protocols, and one or more validation tests, ensuring alignment with the plurality of compliance requirements, industry standards, regulations, and safety protocols.

In an embodiment, the one or more compliance documents may be stored in the memory. Further, in an embodiment, the compliance documents may be generated in one or more formats. In an embodiment, the formats may include but are not limited to, PDF, JPG, PNG, and Word format.

Now referring to FIG. 1 again, the system 100 may be connected to at least one server. The server may include a machine learning (ML) model to generate the compliance document. In an embodiment, the server may be a physical server or a cloud server. In another embodiment, the system 100 may include the ML model and modules associated with the ML model.

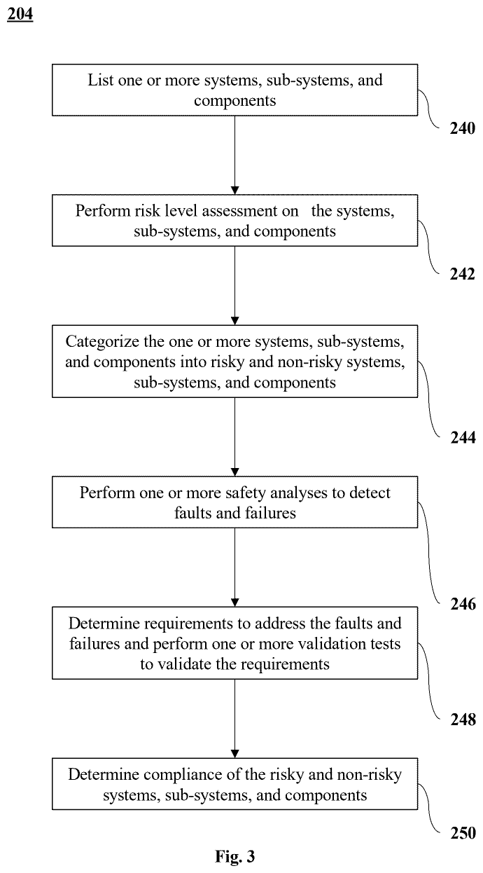

FIG. 3 illustrates a flow diagram of a method for determining one or more system, sub-system, and component requirements, and one or more compliance requirements for a vehicle, to generate the one or more compliance documents for development of the vehicle, in accordance with an embodiment of the present disclosure. The method for determining one or more system, sub-system, and component requirements, and one or more compliance requirements for a vehicle, to generate the one or more compliance documents for development of the vehicle may further include the following steps:

At step 240, the processor may be configured to list one or more systems, sub-systems, and components based on the parameters in the user query, by using the records of existing systems, sub-systems, and components used in different vehicles stored in the data associated with development of different vehicles.

At step 242, the processor may be configured to perform one or more risk level assessments on the one or more systems, sub-systems, and components based on one or more parameters in the user query. The processor utilizes the detailed information about risks associated with a plurality of systems, sub-systems, and components, stored in the data associated with development of different vehicles. The processor may evaluate functional roles of one or more systems, sub-systems, and components to assess associated risk levels.

At step 244, the processor may be configured to categorize the one or more systems, sub-systems, and components into risky and non-risky systems, sub-systems, and components, based on the one or more risk assessments. Risk may be categorized based on potential failure rates, operational criticality, and susceptibility to hazards. For instance, high-risk components like batteries in electric vehicles or braking subsystems in autonomous cars may require enhanced scrutiny and compliance validation.

At step 246, to address the risks associated with the systems, sub-systems, and components, the processor may be configured to perform one or more safety analyses to detect potential faults, failures, and vulnerabilities within vehicle systems, subsystems, and components.

In an aspect of the present invention, the one or more safety analyses may include but are not limited to, fault tree analysis (FTA), design failure mode effects analysis (FMEDA), and failure mode, effects, diagnostics analysis, hazard analysis risk assessment (HARA), and threat and risk assessment (TRA).

In an embodiment the safety analyses are performed using one or more analytic tools. The analytics tools may include but are not limited to, fault tree analysis tool (FTA), design failure mode effects analysis tool, and failure mode, effects, diagnostics analysis tool (FMEDA), hazard analysis risk assessment tool (HARA), and threat and risk assessment tool (TRA). In an embodiment, the analytics tool may be used to develop the safety analyses based on different vehicles and conditions.

The Fault Tree Analysis (FTA) systematically identifies potential faults and examines their cascading effects on the overall system or vehicle. The Design Failure Mode and Effects Analysis (DFMEA) evaluates potential failure modes during the design phase and assesses their impact on system performance. Additionally, the Failure Mode, Effects, and Diagnostics Analysis (FMEDA) integrates diagnostic capabilities to predict failures and propose mitigation strategies. Furthermore, the Hazard Analysis Risk Assessment (HARA) focuses on identifying and mitigating hazards that could compromise vehicle functionality or safety, particularly for safety-critical systems. Furthermore, the Threat and Risk Assessment (TRA) addresses cybersecurity vulnerabilities, ensuring that vehicle operations and data remain secure against potential threats such as hacking, data breaches, and firmware manipulation.

After performing the safety analyses to detect faults and failures, at step 248, the processor may be configured to determine one or more requirements to address the faults and failures and perform one or more validation tests for validating the requirements in the risky and non-risky systems, sub-systems, and components of the vehicle. In an embodiment, the one or more validation tests may include but are not limited to, Hardware-in-the-Loop (HIL) and Software-in-the-Loop (SIL). HIL and SIL simulate real-world operating conditions that include the requirements to address the faults and failures, to validate the performance of hardware and software systems of the vehicle.

Lastly at step 250, the processor may be configured to determine compliance for the risky and non-risky systems, subsystems, and components. The processor may validate each system, sub-system and component against the plurality of compliance requirements stored in the data associated with different vehicles. For example, propulsion systems are validated to ensure compliance with emissions regulations, while braking systems are checked for alignment with international safety standards including but not limited to, UNECE R13 or FMVSS 135. Similarly, electronic control units (ECUs) undergo cybersecurity assessments to confirm adherence to standards including ISO/SAE 21434 or UNECE R155.

### Technical Advancement and Economic Significance

The method disclosed in the present invention for generating a compliance document for development of a vehicle, may have the following advantages over conventional art:

The invention ensures compliance with industry standards, statutory regulations, functional safety, performance, cybersecurity, connectivity, emission, and environmental standards, addressing all aspects of vehicle development from systems to components.

The invention ensures enhanced safety and reliability by developing and integrating rigorous safety analyses, such as Fault Tree Analysis (FTA), DFMEA, FMEDA, HARA, and TRA, which identify and mitigate potential risks and vulnerabilities.

The invention ensures streamlined vehicle development processes by leveraging a centralized database that provides accurate, relevant, and pre-stored information on development of vehicle systems, subsystems, components, and compliance requirements.

The invention ensures accurate and efficient decision-making through automated risk assessments and categorization of systems, subsystems, and components into risky and non-risky groups.

The invention eliminates the need for manual compliance validation, reducing human errors and accelerating the documentation process.

The invention eliminates inconsistencies in compliance reporting by generating comprehensive compliance documents that include functional safety strategies, validation test plans, and detailed system requirements.

The invention ensures adaptability to various vehicle types and use cases, ranging from autonomous electric vehicles to heavy-duty industrial vehicles, by allowing parameter customization in user queries.

The invention ensures robust cybersecurity measures by performing Threat and Risk Assessments (TRA) to safeguard vehicle operations and data integrity against cyber threats.

The invention eliminates redundant development efforts by providing precise and actionable outputs, such as tailored validation test plans and functional safety strategies, which streamline workflows.

The invention ensures reduced time-to-market by automating compliance determination and integrating machine learning for efficient data retrieval and analysis.

The invention ensures scalability and future-proofing by incorporating evolving industry standards, emerging technologies, and updated compliance requirements.

The invention eliminates operational risks by prioritizing high-risk elements and validating their compliance rigorously, ensuring safer vehicle designs and deployments.

The specification may refer to “an”, “another”, “one” or “some” embodiment(s) in several locations.

This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skills in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Although implementations of a method for generating a compliance document for development of a vehicle have been described in language specific to structural features and/or methods, it is to be understood that the appended claims are not necessarily limited to the specific features or methods described. Rather, the specific features and methods are disclosed as examples of implementations of a method for generating a compliance document for development of a vehicle.

The invention has been described above with reference to numerous embodiments and specific examples. Many variations will suggest themselves to those skilled in this art in light of the above-detailed description. All such obvious variations are within the full intended scope of the appended claims.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for generating one or more compliance documents for development of a vehicle, comprising:
receiving a user query, wherein the user query includes one or more parameters associated with the development of the vehicle,
wherein the parameters include at least one of, one or more use cases, weight class, performance targets, components, energy type, propulsion type, software features, operational scenarios, weather considerations, network topology, and communication protocols of the vehicle;
determining, via a processor, one or more system, sub-system and component requirements, and plurality of compliance requirements for the vehicle, using data associated with development of different vehicles, based on the parameters in the user query,
wherein the data associated with the development of different vehicles are stored in a memory connected to the processor and,
wherein the data associated with development of different vehicles comprises a plurality of systems and sub-systems required to develop different vehicles, one or more components required for different vehicles based on different parameters of a vehicle, one or more risk levels associated with the systems, sub-systems, and components, a plurality of compliance requirements, and a plurality of validation tests associated with different vehicles; and
generating, by using the one or more system, sub-system, and component requirements, and the plurality of compliance requirements for the vehicle, the one or more compliance documents for the development of the vehicle.

2. The method as claimed in claim 1, wherein the plurality of compliance requirements includes one or more functional safety and performance, cybersecurity, connectivity, emission, and environmental standards.

3. The method as claimed in claim 1, wherein determining one or more system, sub-system, and component requirements, and one or more compliance requirements for the vehicle, further comprises steps of:
listing one or more systems, sub-systems, and components based on the parameters in the user query, by using the data associated with development of different vehicles;
performing risk level assessment on the systems, sub-systems, and components based on one or more parameters in the user query;
categorizing the one or more systems, sub-systems, and components into risky and non-risky systems, sub-systems, and components;
performing one or more safety analyses for detecting faults and failures in the risky systems, sub-systems, and components of the vehicle;
determining one or more requirements to address the faults and failures;
performing one or more validation tests for validating the requirements in the risky and non-risky systems, sub-systems, and components of the vehicle; and
determining compliance of the risky and non-risky systems, sub-systems, and components with the plurality of compliance requirements stored in the data associated with development of different vehicles.

4. The method as claimed in claim 3, wherein the safety analyses include fault tree analysis (FTA), design failure mode effects analysis, failure mode, effects and diagnostics analysis (FMEDA), hazard analysis risk assessment (HARA), and threat and risk assessment (TRA).

5. The method as claimed in claim 1, wherein the one or more compliance documents include one or more system, sub-system, and component requirements, one or more compliance requirements, one or more Functional Safety (FUSA) and cybersecurity strategies or protocols, and one or more validation tests and results, ensuring alignment with compliance requirements, industry standards, regulations, and safety protocols.

6. A system to generate one or more compliance documents for development of a vehicle, as claimed in claim 1, the system comprising:
a processor; and
a memory connected to the processor to store computer-executable instructions and data associated with development of different vehicles,
wherein the data associated with the development of different vehicles comprise a plurality of systems and sub-systems required to develop different vehicles, one or more components required for different vehicles based on different parameters of a vehicle, one or more risk levels associated with the systems, sub-systems, and components, a plurality of compliance requirements for different types of vehicles, and a plurality of validation tests associated with vehicles, and
wherein when the computer-executable instructions are executed by the processor, cause the processor to:
receive a user query, wherein the user query includes one or more parameters associated with the development of the vehicle,
wherein the parameters include at least one of, one or more use cases, weight class, performance targets, components, energy type, propulsion type, software features, operational scenarios, weather considerations, network topology, and communication protocols of the vehicle;
determine one or more system, sub-system, and component requirements, and one or more compliance requirements for the vehicle, using the data associated with the development of different vehicles, based on the parameters in the user query; and
generate the one or more compliance documents for the development of the vehicle, by using the one or more system, sub-system, and component requirements, and the one or more compliance requirements for the vehicle.
